(19) United States
(12) Patent Application Publication
(10) Pub. No.: US 2006/0108796 A1
(43) Pub. Date: May 25, 2006

(54) Highly tight connection device

(76) Inventor: Stefan Welle, HUGELSHIEM (DE)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 10/527,237

(22) PCT Filed: Sep. 4, 2003
(86) PCT No.: PCT/EP03/09837

§ 371 Date: Sep. 22, 2005

(30) Foreign Application Priority Data
Sep. 10, 2002 (DE) 102 41 921.3

(51) Int. Cl. F16L 41/00

(52) U.S. Cl. 285/205

(57) ABSTRACT

The invention relates to a connection device (1) comprising a connection piece (7) which is arranged in a sealing manner, on the front side thereof, on a sealing surface (15) of an element (3). The orientation of the connection piece (7) in relation to the sealing surface (15) is determined only by the surface contact between the connection piece (7) and the sealing surface (15) (with or without a sealing element interposed). A pivotably mounted clamping lever (21) adjacent to the sealing site applies the required axial force, a tensioning device (32) acting on the longer lever arm thereof. One such connection device is especially easy to produce and to assemble, and is particularly reliable, leakproof and easy to mount.

The present invention relates to a connection device for connecting a fluid conduit with another element.

As a rule, fluid-carrying systems comprise several connection devices for the connection of, e.g., pipes or hoses with each other or for the connection to other aggregates such as compressors, condensers, coolers, evaporators or other assemblies. Such connection devices must provide a tight seal under the specified conditions. Particularly high demands are made on a connection device when high fluid pressures, fluctuating between various pressure values, act on the connection device. A minimum-possible leak rate is required in the case of closed fluid systems.

In so doing, low-molecular fluids such as CO₂ make particularly high demands. In addition, frequently otherwise peripheral conditions must be taken into consideration; these include thermal stability, resistance to vibrations, resistance to corrosion, long-term durability, easy assembly, easy maintenance and the like.

U.S. Pat. No. 5,513,882 discloses a connection device which comprises a cup-shaped receiving element and, associated therewith, a pipe end with a radial flange. An O-ring is arranged concentrically to a fluid passage channel in a circular groove at the bottom of the cup-shaped receiving element. The annular flange of the counterpart is supported on this O-ring and the surrounding annular regions of the bottom. In order to secure this connection, a U-shaped bracket is inserted, transversely to the connection piece, through appropriate bores of the cup. The O-ring creates the seal.

Furthermore, German document DE 100 58 087 A1 discloses a connection device which also comprises a connection piece with a radial flange and a cup-shaped receiving element, with an O-ring located on the bottom of said cup-shaped element. In order to achieve a specific deformation of the O-ring and to achieve a tight mechanical connection of the components of the connection device, said device is associated with a wedge-type tensioning device. The latter comprises a clamping wedge which wedges the radial flange tightly against the abutment surfaces on the cup-shaped component.

In view of this, it is the object of the invention to provide a connection device which is suitable in particular for fluid-carrying systems in which the fluid is at least temporarily under high pressure.

This object is achieved with the connection device as in Claim 1:

The connection device is used for connecting a fluid conduit with another element which is provided with at least one sealing surface. The other element may be a component of a fluid-carrying system, an aggregate or any other element such as a coupling piece or the like. The conduit end to be connected has a radial projection which can come into contact with a clamping lever in order to clamp the conduit end in axial direction against said element. A sealing element that takes into account the characteristics of the fluid to be sealed in, as well as the pressures of said fluid, is interposed between the axial sealing surface of the conduit end and the sealing surface of said element.

The clamping lever comprises a support section for support on an abutment, a pressure or thrust surface associated with the radial projection and a mounting section, which can come into contact with a tensioning device that is configured as a screw, for example. The pressure surface is located between the support section and the mounting section. Preferably, the lever arm provided between the pressure surface and the abutment or support section is considerably shorter than the lever arm provided between the abutment and the mounting section or the tensioning device. In so doing, due to the resultant lever reduction, a single tensioning device, for example, a single screw, can be used to create an extremely high axial tension force that acts on the conduit end. The pressure prevailing in the fluid system acts—via the circular surface enclosed by the sealing surface—as an axial force attempting to move the conduit end away from the element. If the connection device is to be tight up to a bursting pressure of several hundred Bar, even a small cross-section of, e.g., one square centimeter, can result in a considerable axial force of several thousand Newtons. By using relatively minimally sized tensioning devices (for example, machine bolt M5 or M6), these forces can be safely controlled.

Preferably, the pressure surface acts only on the center of the radial flange. Specifically, this may be a line-shaped or strip-shaped surface area, which is oriented parallel to a hinge axis defined by the abutment. The linear or areal contact region extends, in radial direction to the radial projection, transversely with respect to the clamping lever, and is located on a line passing through the center of said radial projection. As a result of this, the pressure exerted by the clamping lever is transmitted uniformly to the axial sealing surface and to the sealing surface created on the element, so that the sealing element is subjected to a uniform axial pressure along its entire periphery. Consequently, local leakages caused by an asymmetrical distribution of forces are avoided.

The clamping lever exerts an axial force on the conduit end, in which case the sealing surface of the element serves as reference surface for the alignment of the conduit end. The exact alignment of the conduit end relative to the element thus is defined only by the sealing surface and the axial sealing surface, and not by any other surface contacts. This measure provides the basis for a uniform surface pressure on the sealing element, thus allowing particularly low leak rates and high pressure resistance. In addition, the conduit end may be provided with support elements, said support elements supporting said conduit end when bending forces are applied to it. The alignment in a no-force state, however, is achieved exclusively by way of the sealing surface and the axial sealing surface. When resilient sealing elements are used, the element or the radial projection may additionally have a support surface which prevents excessive compression of the sealing element. In both cases, however, the alignment of the conduit end on the element will be defined in the proximity of the sealing site by the surfaces at said site, and not by the mounting device created by the clamping lever.

The conduit end may be provided with a connection piece which has a radial projection. The latter may be an annular or disk-shaped flange, which may be continuous or discontinuous in peripheral direction. This connection piece may be soldered or welded to the fluid conduit, or it may be otherwise connected with said conduit.

It is also possible to mold the radial projection to the fluid conduit, so that the connection piece and the fluid conduit are designed in one piece.

The axial sealing surface, preferably, is a plane surface; however, if required, it may be configured as a conical seat.

The sealing element may be an O-ring, preferably a metal O-ring. This O-ring consists, for example, of a small endless circular spring steel tube which is filled with pressurized gas (nitrogen). Preferably, the seal is created by a sheet gasket, which is flat from the start, in axial direction. For example, it may consist of a metal disk coated with a sealing material. This sealing material may be a thin elastomer layer. Also, it may consist of a thin deformable layer of a metal exhibiting a deformability which is greater than that of the metal disk. In so doing, extremely low leak rates with high mechanical stability and high resistance can be achieved.

The clamping lever may be mounted to the conduit to be connected in such a manner that said lever cannot be lost. In this case, the lever has an opening with a closed edge that extends through the conduit end. However, it is also possible to provide a discontinuous edge, so that the clamping lever may be mounted to the conduit end if desired.

Additional details of advantageous embodiments of the invention are obvious from the description, the drawing and the subclaims.

The drawings depict examples of embodiment of the invention. They show in

FIG. 1 a schematic illustration of the connection device, in longitudinal section;

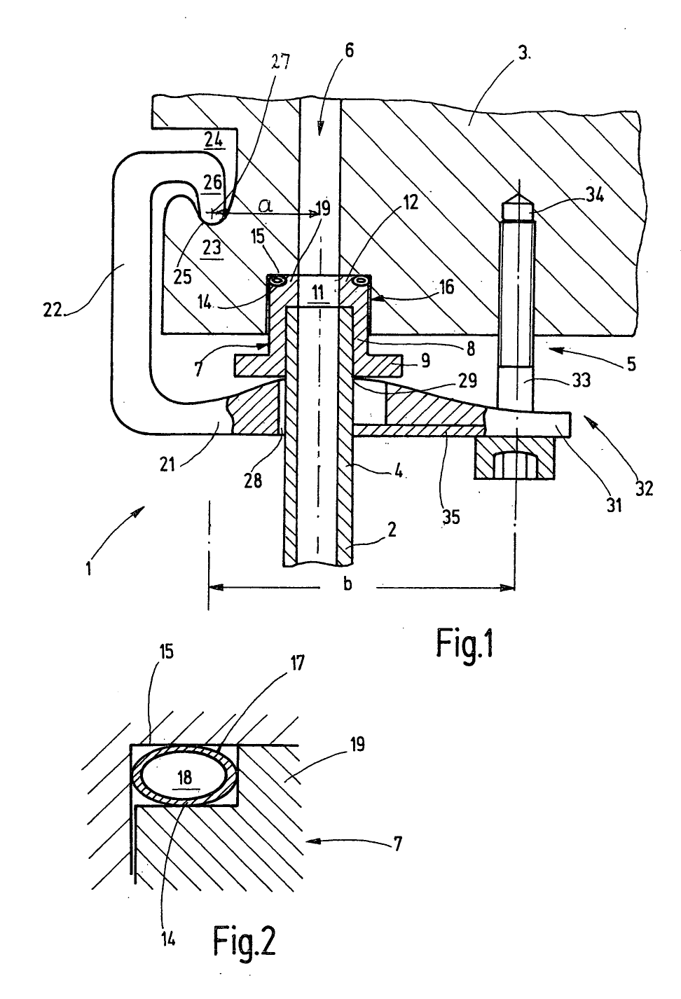

FIG. 2 a detail of the connection device as in Claim 1;

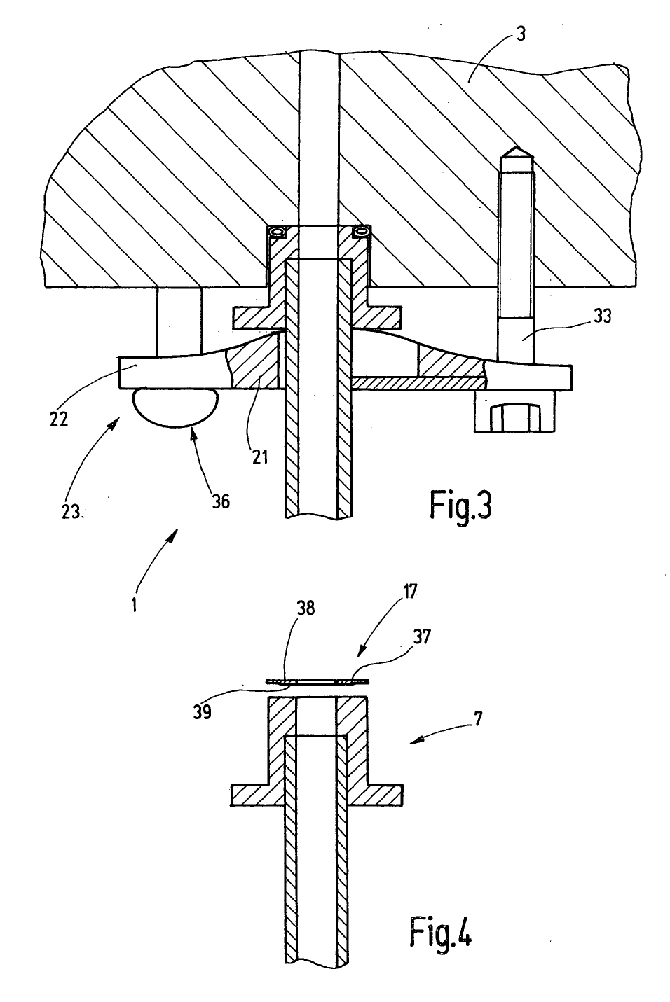

FIG. 3 a schematic illustration of a modified embodiment of a connection device, in longitudinal section;

FIG. 4 a detail of a further modified embodiment of the connection device, in longitudinal section;

FIG. 5 a sectional view of a sealing element for a connection device as in FIG. 4;

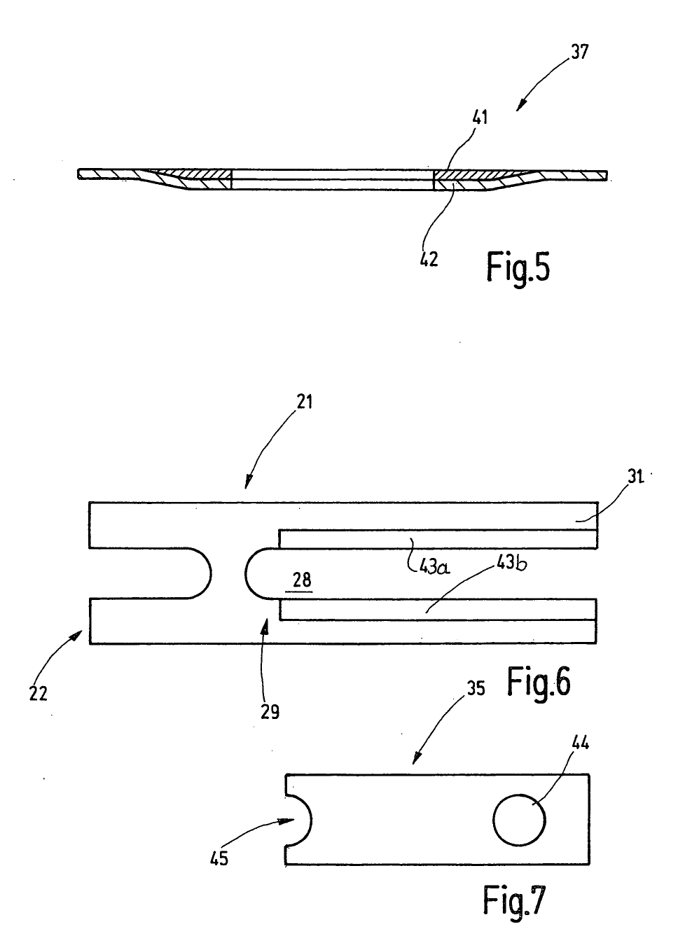

FIG. 6 a plan view of a modified embodiment of a clamping lever for the connection device as in FIG. 3; and,

FIG. 7 a plan view of a closing piece associated with the clamping lever as in FIG. 6.

FIG. 1 depicts a connection device 1 as can be used for connecting a fluid conduit 2 to another element 3 which may be a fluid-technical arrangement, a conduit or the like. Connection device 1 comprises a conduit end 4 of fluid conduit 2 and a connection region 5 of element 3. A fluid channel 6, which is sealed toward the outside, passes through both. Conduit end 4 is provided with a connection piece which consists of a segment 8 configured as a hollow cylinder having a cylindrical inner surface and a cylindrical outer surface. On the end away from element 3, a disk-shaped flange creating a radial projection 9 adjoins segment 8. On its other axial end, connection piece 7 has a bottom 12 with a central through-bore 11, said bottom having an axial sealing surface 14. Axial sealing surface 14 is an annular surface, which is concentric with respect to fluid channel 6 and is flat in the present example of embodiment. The axial sealing surface is also associated with an annular flat sealing surface 15, which is arranged on element 3 such that it is co-axial with fluid channel 6. Sealing surface 15 is provided on the bottom of a pocket bore 16, through which a fluid channel 6 passes and which has a cylindrical inner wall with a diameter exceeding the outside diameter of connection piece 7. Hence said connection piece is seated with play in pocket bore 16.

As is separately depicted in FIG. 2, a sealing element 17 is interposed between axial sealing surface 14 and sealing surface 15. In the present embodiment, sealing element 17 consists of a metal O-ring. This metal sealing O-ring, which is thorus-shaped in relaxed state, is a self-contained, and thus continuous, small spring steel tube having a cavity 18 that is filled with pressurized nitrogen.

Directly adjoining axial sealing surface 14, connection piece 7 has a projection 19 having an axial end surface that abuts on the bottom of pocket bore 16, thus limiting the deformation of sealing element 17 and creating a snug abutment of connection piece 7.

Furthermore, connection device 1 comprises a clamping lever 21 (FIG. 1), which is used to press connection piece 7 in axial direction against the bottom of pocket bore 16. To accomplish this, clamping lever 21 has a support section 22, which is used to support clamping lever 21 on element 3. In the present embodiment, support section 22 is configured as a hook, which extends around an abutment 23 provided on element 3. This abutment, for example, is a recess 24 having a groove-shaped support surface 25 facing away from pocket bore 16. A lug 26 adapted to the curvature of support surface 25 abuts against support surface 25. The curvatures of support surface 25 and of lug 26 define a swivel axis 27 which can be viewed as a hinge axis.

In addition, conduit end 4 extends through an opening 28 of clamping lever 21. Adjoining this opening 28 is a pressure surface 29 which, preferably, is slightly convex or domed. Consequently, considering the depiction in FIG. 1, pressure surface 29 abuts only above and below the plane of projection in line-shaped or strip-shaped regions against the flat radial projection 9. Consequently, this region of contact is on a line perpendicular to the plane of projection, which is in parallel alignment with swivel axis 27. Distance a between the hinge axis or swivel axis 27 and the radial position of surface contact between pressure surface 29 and radial projection 9, which is to be measured in a direction transverse to the conduit end, forms a short lever arm. The distance between swivel axis 27 and the machine screw forms a long lever arm b.

On its end opposite support section 22, clamping lever 21 has a mounting section 31, which is associated with a tensioning device 32 configured, e.g., as a machine screw 33. The latter is screwed into a threaded bore 34 of element 3 and passes through mounting section 31 of clamping lever 21. The distance b to be measured horizontally, or transversely to conduit end 4, between swivel axis 27 and machine screw 33 forms a longer lever arm for tensioning connection device 1.

In an appropriate recess or groove of clamping lever 21, a clamping element 35 may be provided, through which extends machine screw 33 if an appropriate bore exists. Preferably, this bore is longitudinal, or it is at least slightly larger than machine screw 33. Said clamping element extends approximately to conduit end 4 so as to have one support surface face said conduit end. Viewed from conduit end 4 in the direction of mounting section 31, opening 28 is considerably larger, so that the wall of the opening does not offer any support to conduit end 4 at this point. This function is performed by clamping element 35. However, clamping element 35 is preferably configured and arranged in such a manner that conduit end 4, with connection device 1 tensioned, moves through opening 28 in force-free state and without contacting the wall. The aim of this is to allow the alignment of conduit end 4 to be defined solely by the abutment of projection 19 against the bottom of pocket bore 16.

The function of the connection device 1 described so far is as follows:

In order to establish a connection, a fluid conduit 2 is assumed to be provided with the appropriate connection piece 7 and clamping lever 21. Now, connection piece 7 with its sealing element 17 is inserted in pocket bore 16 and clamping lever 21 is hooked around abutment 23. This is easily possible because clamping element 35 is still removed due to a lateral movement of clamping lever 21. Then, machine screw 33, along with clamping element 35, is inserted in mounting section 31 of clamping lever 21 and tightened. In so doing, the axial tension force of machine screw 13 acts as an axial clamping force, increased by a factor b/a, on connection piece 7, pressing said connection piece into pocket bore 16. In so doing, neither the alignment of the clamping lever nor any other adjustments are critical. The surface pressure on the end side of connection piece 7 is largely constant along the periphery. The deformation of sealing element 17 is limited by the abutment of projection 19 against the bottom of pocket bore 16. Particularly low leak rates are achieved due to the metal-to-metal joint.

FIG. 3 depicts a modified embodiment of connection device 1. The description as given for FIGS. 1 and 2 above applies correspondingly. Different therefrom, the connection device 1 of FIG. 3 is characterized by the following:

Abutment 23 is created by a mushroom-shaped projection 36, which is arranged on element 3 and extends parallel to machine screw 33 away from said element. The fork-shaped end of support section 22 of clamping lever 21 extends under the mushroom cap of projection 36. The advantage of this embodiment is its simplicity. However, as a rule, the lever ratio b to a is slightly less favorable in this case, i.e., the force gain is lower. The connection device 1 of FIG. 1 has the advantage that the swivel and hinge axis 27 can be located in extremely close proximity of fluid channel 7; therefore, distance a can be made very small and ratio b/a can be made very large.

The embodiment of connection piece 7 and sealing element 17 depicted in FIG. 4 can be used in each of the above and below described forms of embodiment. Sealing element 17 is configured as a gasket 37 with two essentially flat sealing surfaces 38, 39 that face away from each other.

FIG. 5 shows gasket 37 by itself. It has a metal support 41 consisting of a hard, minimally deformable material. This support is provided with a thin sealing layer 42 of an elastomer or a deformable metal such as soft aluminum, lead, tin or the like. Gasket 37 is placed between the flat end side of connection piece 7 and the bottom of pocket bore 16. Consequently, axial sealing surface 14 is supported—via gasket 37—directly on sealing surface 15. In this type of seal, gasket 37 defines the alignment of the conduit end 4 of element 3. Clamping lever 21 only exerts an axial pressure, while no lateral or any other forces generated from the side of the connection device act on connection piece 7.

FIGS. 6 and 7 depict a clamping lever 21 with its associated clamping element 35 by themselves. Clamping lever 21 shown in FIG. 6, for example, can be used in connection device 1 of FIG. 3. The clamping lever has an opening 28, which extends slit-like beyond mounting section 31. It terminates in the region of pressure surface 29. In order to support projection 36, support section 22 also has the configuration of a fork. Slit-like opening 28 has, on its longitudinal edges, a stepped edge 43a, 43b, which receives the clamping element. This clamping element has an opening 44 for machine screw 33 and, on its narrow end, a recess 45 in order to define—together with the end-side edge of opening 28—a round opening for passing through conduit end 4. This clamping lever permits the mounting of fluid conduits 2 with connection pieces 7 to arrangements 3, without, beforehand, mounting the appropriate clamping lever 21 to the respective fluid conduit 2.

Connection device 1 has a connection piece 7, the end side of which is seated on a sealing surface 15 of an element 3. The alignment of connection piece 7 relative to sealing surface 15 is defined exclusively by the surface contact between connection piece 7 and sealing surface 15 (with or without interposing a sealing element 17). A pivotably mounted clamping lever 21 adjacent the sealing site applies the required axial pressure, a tensioning device 32 acting on the longer lever arm of said lever. Such a connection device is particularly easy to manufacture and assemble and, in addition, is exceedingly easy to mount, and is reliable, as well as leakproof.

1. Connection device (1) for connecting a fluid conduit (2) with another element (3) having a sealing surface (15),
with a conduit end (4) associated with the fluid conduit (2) and having a radial projection (9) and an axial sealing surface (14),
with a sealing element (17) interposed between the axial sealing surface (14) and the sealing surface (15),
with a clamping lever (21) having a support section (22) for support on an abutment (23) provided on the element (3), a pressure surface (29) associated with the radial projection (9), and a mounting section (31) with which said radial projection can be pressed against the element (3) by means of a tensioning device (32).

2. Connection device as in claim 1, characterized in that the conduit end (4) is provided with a connection piece (7) having a radial projection (9).

3. Connection device as in claim 1, characterized in that the connection piece (7) is soldered to the fluid conduit (2).

4. Connection device as in claim 1, characterized in that the radial projection (9) is molded to the fluid conduit (2).

5. Connection device as in claim 1, characterized in that the radial projection (9) is created by a disk flange.

6. Connection device as in claim 1, characterized in that the axial sealing surface (14) is a plane surface.

7. Connection device as in claim 1, characterized in that the axial sealing surface (14) is adjacent a support projection (19).

8. Connection device as in claim 1, characterized in that the sealing element (17) is a metal O-ring.

9. Connection device as in claim 1, characterized in that the sealing element (17) is a metal gasket (37) coated with a sealing material.

10. Connection device as in claim 9, characterized in that the sealing material is an elastomer.

11. Connection device as in claim 1, characterized in that the sealing material is a metal exhibiting a deformability greater than that of the metal gasket (12).

12. Connection device as in claim 1, characterized in that the fluid conduit (2) extends through an opening (28) of the clamping lever (21).

13. Connection device as in claim 12, characterized in that the opening (28) has a continuous edge.

14. Connection device as in claim 12, characterized in that the opening (28) has a discontinuous edge.

15. Connection device as in claim 1, characterized in that the support section (22) of the clamping lever (21) and the abutment (23) form a hinge.

16. Connection device as in claim 1, characterized in that the pressure surface (29) is a convex surface.

17. Connection device as in claim 1, characterized in that the pressure surface (29) is in central contact with the radial projection (9).

18. Connection device as in claim 1, characterized in that tensioning device (32) is configured as a screw (33).
